(19) United States
(12) Patent Application Publication
(10) Pub. No.: US 2008/0168659 A1
(43) Pub. Date: Jul. 17, 2008

(54) UTENSIL WITH GRAPHICAL REPRESENTATION OF FUNCTION

(75) Inventor: William J. Lazaroff, Floral Park, NY (US)

Correspondence Address: TROUTMAN SANDERS LLP, 600 PEACHTREE STREET , NE, ATLANTA, GA, 30308, US

(73) Assignee: Lifetime Brands, Inc., Garden City, NY (US)

(21) Appl. No.: 12/013,980

(22) Filed: Jan. 14, 2008

Related U.S. Application Data
(60) Provisional application No. 60/885,064, filed on Jan. 16, 2007.

(51) Int. Cl. A47J 17/04; B62B 3/00; A46B 9/02; B07B 13/00; A47J 25/00

(52) U.S. Cl. 30/113.1; 30/165; 30/114; 15/160; 241/83

(57) ABSTRACT

A specialized utensil including a functional tool disposed on one end of the utensil and a handle disposed on a second end of the utensil, wherein the handle comprises a graphical illustration of the function of the utensil and a item that the functional tool is designed to be used on.

### CROSS REFERENCE TO RELATED APPLICATION

This application claims benefit under 35 U.S.C. §119(e) of U.S. Provisional Patent Application Ser. No. 60/885,064 filed 16 Jan. 2007, which priority application is hereby incorporated by reference.

### BACKGROUND OF THE INVENTION

1. Field of the Invention

The present invention relates generally to utensils, and in particular to utensils with indication means representing the function of the particular utensil.

2. Description of Related Art

In many applications, such a cooking, individuals utilize a wide variety of similarly shaped and sized tools or utensils to facilitate the performance of specific specialized tasks that each requires the use of a specialized tool. For example, in the area of food preparation utensils such as apple corers, potato peelers, lemon zesters, avocado slicers, can openers, melon balers, and the like are commonly used to perform specialized tasks. Due to their common shape and size and infrequent use, such utensils are often stored in a common drawer or container in a kitchen. Identifying a desired utensil located in such a common container filled with numerous similarly shaped and sized utensils can often be a frustrating and time consuming task.

Another drawback of such specialized utensils or tools is that their function can not be evident to those that are unfamiliar with them. For example, an individual unfamiliar with the function of each individual utensil can not be able to readily identify each utensil, and can therefore attempt to use the wrong utensil to perform a task.

What is needed, therefore, is a utensil that allows an individual to quickly identify a desired utensil. Further, what is needed is a utensil that allows a user that is unfamiliar with the utensil to identify the function of the utensil.

### BRIEF SUMMARY OF THE INVENTION

Briefly described, the present invention comprises a utensil having indication means representing the function of the particular utensil. In a first preferred embodiment, the indication means is a graphical representation of the function of the utensil at the handle of the utensil. In another preferred embodiment, the indication means can assist an individually that is visually impaired, the indication means being raised indicia, for example, a strip of Braille information, at the handle of the utensil that indicates the particular use of the utensil. In another preferred embodiment, the indication means can assist an individually that is visually impaired, the indication means being a broadcast of the name of the utensil when the utensil is touched.

It is thus one object of the present invention to provide a utensil for an item, preferably a food item, comprising a tool end for acting on the item and indication means representing the item. In a preferred embodiment, the indication means is located at the handle of the utensil.

The indication means can comprise a two-dimensional representation of the item, or in some embodiments, a three-dimensional representation of the item.

The indication means can illustrate one or both of the food item, and the use of the utensil on the item. For example, for a lemon zester, the indication means can comprise a drawing/photo of a lemon and/or a zested lemon.

If two-dimensional, the indication means can be located on the outer surface of the handle, or in a recess of the handle, under an at least translucent cover, the cover providing the continuous outer surface of the handle.

If three-dimensional, the indication means can be located fully within a recess of the handle, under an at least translucent cover, the cover providing the continuous outer surface of the handle, or portions of the three-dimensional representation can extend outside the recess, to provide, for example, a touchable representation of the use of the utensil for a visually impaired user.

In the first preferred embodiment, the handle can include graphical representations of the actual use of the utensil or can include a graphical representation of the item for which the utensil is designed to be used on. The graphical representation of the item for which the utensil is to be used on can include multiple images of the item, including illustrations of the item before the use of the utensil, at various stages of use of the utensil, and/or after use of the utensil. Furthermore, the handle of the utensil can be predominantly colored with the color of the item that the utensil is designed to be used on to further facilitate the identification of the utensil.

In another preferred embodiment, the present invention comprises a cutlery device having indication means representing the function of the particular cutlery. For example, a knife can include a tool end for acting on a food item, being a blade, and an indication means representing what the knife is best suited for. In such an embodiment, a knife can include a blade, a handle, and a sheath, wherein the blade is provide with, for example, a graphic of a cow, which upon removal of the sheath, is visible, and thus provides the user with the indication that the particular knife is a slicer. Further, the sheath can be provided with the same or similar graphic. This line of cutlery can include, for example, a fillet knife with a graphic representation of a filleted fish on the sheath, blade and/or handle, a paring knife with a graphic of fruits and/or vegetables, a chef knife with a graphic of poultry, and a utility knife with a graphic of, for example, a bread loaf.

These and other objects, features and advantages of the present invention will become more apparent upon reading the following specification in conjunction with the accompanying drawings.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A is a side view of a lemon zester according to an exemplary embodiment of the present invention.

FIG. 1B is a top view of the lemon zester of FIG. 1A, wherein looking through a portion of the handle can be seen a graphical representation of a lemon, and the function of the lemon zester.

FIG. 1C is a view of the graphic element of the lemon zester, illustrating a lemon, and the function of the lemon zester.

FIGS. 2A-C illustrates an apple corer in accordance with another exemplary embodiment of the present invention.

FIGS. 3A-C illustrates an avocado slicer in accordance with another exemplary embodiment of the present invention.

The detailed description explains the exemplary embodiments of the invention, together with advantages and features, by way of example with reference to the drawings.

### DETAILED DESCRIPTION OF THE EXEMPLARY EMBODIMENTS

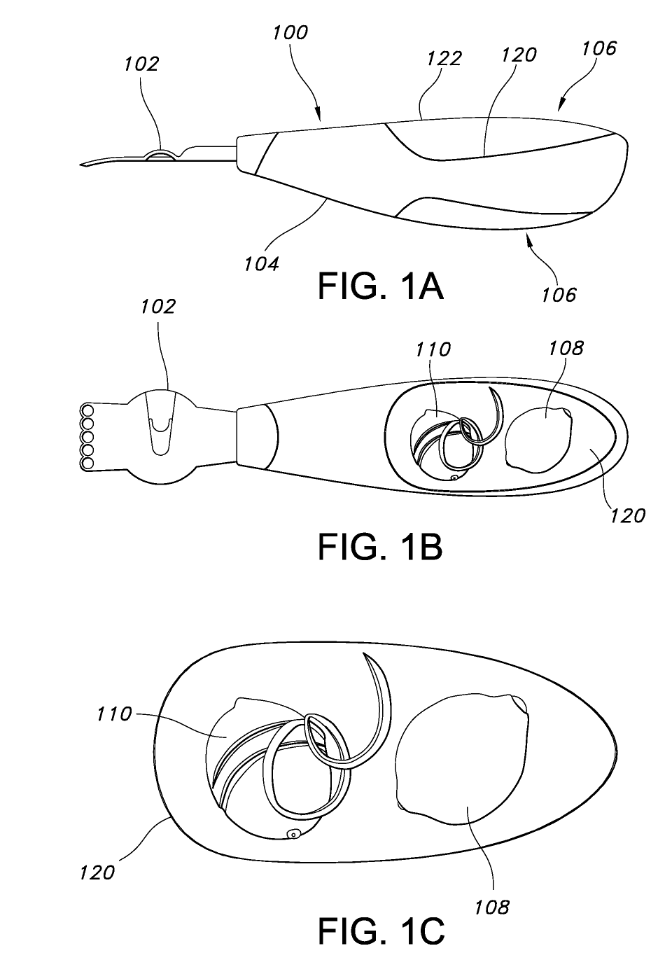

The present invention 100 (shown in FIGS. 1A-C as a lemon zester) comprises a utensil having indication means 106 representing the function of the particular utensil. The indication means 106 can be located at the handle portion 104 of the utensil, although it not need be so located. For example, if the utensil is a cutlery item, like a knife including a blade portion, a handle portion, and a sheath for the blade, the indication means can be located on one or more of the blade portion, the handle portion, and the sheath.

The indication means 106 can comprises a graphical representation of the item for which the utensil is to be used on, the graphical representation being located within the handle, under a translucent/transparent window section of the handle.

The indication means 106 can comprise visually-impaired indication means, for example, a specific texture, or strip of Braille, or a broadcast of the utensil's name and or use upon activation, for example, the individual touching the utensil.

FIG. 1A illustrates a utensil with an indication means 106 that can be such a graphical representation, or be an area of Braille or the like, or be an activation zone that upon touch or other means of activation, activates a pre-recorded voice transmission of the name or use of the utensil. The graphical representation in such an embodiment can be a three dimensional representation of the food item used with the utensil, wherein the three dimensional representation can be felt by the user to discern the use of the utensil.

In a preferred embodiment, the present utensil includes a handle on a first end with a graphical representation of the function of the utensil. The utensil is designed to perform a specific function, and accordingly includes a functional tool disposed on a second end of the utensil.

The handle of the utensil can include a graphical representation of the actual use of the utensil and can also include a graphical representation of the item for which the utensil is designed to be used on. In exemplary embodiments, the graphical representation of the item for which the utensil is to be used on can further include multiple images of the item including illustrations of the item before the use of the utensil, at various stages of use of the utensil, or after use of the utensil. Furthermore, the handle of the utensil can be predominantly colored the color of the item that the utensil is designed to be used on to further facilitate the identification of the utensil.

Various specialized utensils including, a lemon zester 100, an apple corer 200, and an avocado slicer 300 are discussed in more detail with reference to FIGS. 1A-3C. Various alternative exemplary embodiments will be apparent to one of ordinary skill in the art. For example, the utensil further can be, among others, a melon cutter, lettuce knife, basting brush, tomato corer and a cheese grater.

The specialized utensils can be constructed in numerous manners and out of numerous various materials. In one example, a specialized utensil can include a simple wooden handle, which can be painted a specific color, that has a sticker illustrating the item the specialized utensil is designed to be used on and the function of the specialized utensils. In another example, the handle can be made of a composite material and can include a graphical representation of the function of the utensil either in or on a handle of the utensil. Various additional constructions of the specialized utensil are contemplated and will be readily apparent to those of ordinary skill in the art.

### Lemon Zester

Turning now in detail to the drawing figures, wherein like reference numerals represent like parts throughout the several views, the present invention of FIGS. 1A-C illustrate an lemon zester 100, which permits a user to easily identify it as a lemon zester via an indication means 106. The indication means 106 can be a graphic portion 106 including a graphic element 120 located within the handle portion 104, under a see-through element 122. The see-through element 122 can be a plastic cover that provides the handle portion 104 with a relatively seamless outer surface forming the handle.

The graphic element 120 can be a sticker or the like upon which is illustrated the function of the lemon zester 100. The lemon zester 100 includes a functional tool portion 102 disposed on one end of the lemon zester 100 and a handle portion 104 disposed on the opposite end of lemon zester 100. The handle portion 104 includes the graphic element 120 that illustrates a lemon 108, which is the item that the lemon zester 100 is designed to be used on. Additionally, the graphic element 120 also illustrates a zested lemon 110 that shows the function of the lemon zester 100. In exemplary embodiments, the handle portion 104 of the lemon zester 100 can be predominantly yellow, or the color of a lemon, to aide a user in the expeditious identification of the lemon zester 100.

In exemplary embodiments, the graphic element 120 can be a sticker disposed on the surface of the handle portion 104. In another exemplary embodiment, the graphic portion 106 can comprise a multi-layered image that includes one or more graphic elements 120 being decorative layers, and one or more transparent layers 122 formed on top of the decorative layers. The multi-layered image can be embedded in the handle portion 104 of the lemon zester 100. In one embodiment, the multi-layered image can extend through the handle portion 104, such that at least a portion of the handle portion 104 is completely transparent. In another exemplary embodiment, the multi-layered image is inlayed in the handle portion 104 and extends partially through the handle portion 104. The decorative layer of the multi-layered image can include a two-dimensional illustration of a lemon 108 and a zested lemon 110 or a three dimensional lemon 108 and zested lemon 110.

The indication means 106 can wholly enclose the two-dimensional illustration of a lemon 108 and a zested lemon 110 (as shown in FIGS. 1A and 1B), can wholly enclose three-dimensional representations of a lemon 108 and a zested lemon 110 under the see-through element 122, or portions of the three-dimensional representations of a lemon 108 and a zested lemon 110 can extend beyond the smooth surface of the handle, such that portions of the three-dimensional representations are touchable elements of the handle that can help one discern the use of the utensil by touch.

Indication means 106 can be located at more than one location, for example, there can be an upper and lower graphic portion 106, as shown in FIG. 1A.

In exemplary embodiments, at least a portion of the handle portion 104 of the lemon zester 100 can be coated in a suitable non-slip material. The non-slip material (if not at least translucent) can cover the entire handle portion 104 that is not used by the graphic portion 106. The non-slip material is to prevent the lemon zester 100 from slipping in a users hand during use.

Additionally, the lemon zester 100 is constructed of materials that are designed to be dish-washer safe such that any graphical illustration or three-dimensional representation will not be damaged or faded by exposure to water and dish detergent. In exemplary embodiments, the functional tool 102 is releasably secured to the handle, and thus removable from the handle portion 104. For example, the functional tool 102 can be designed to be removed from the handle portion 104 for cleaning or replacement.

### Apple Corer

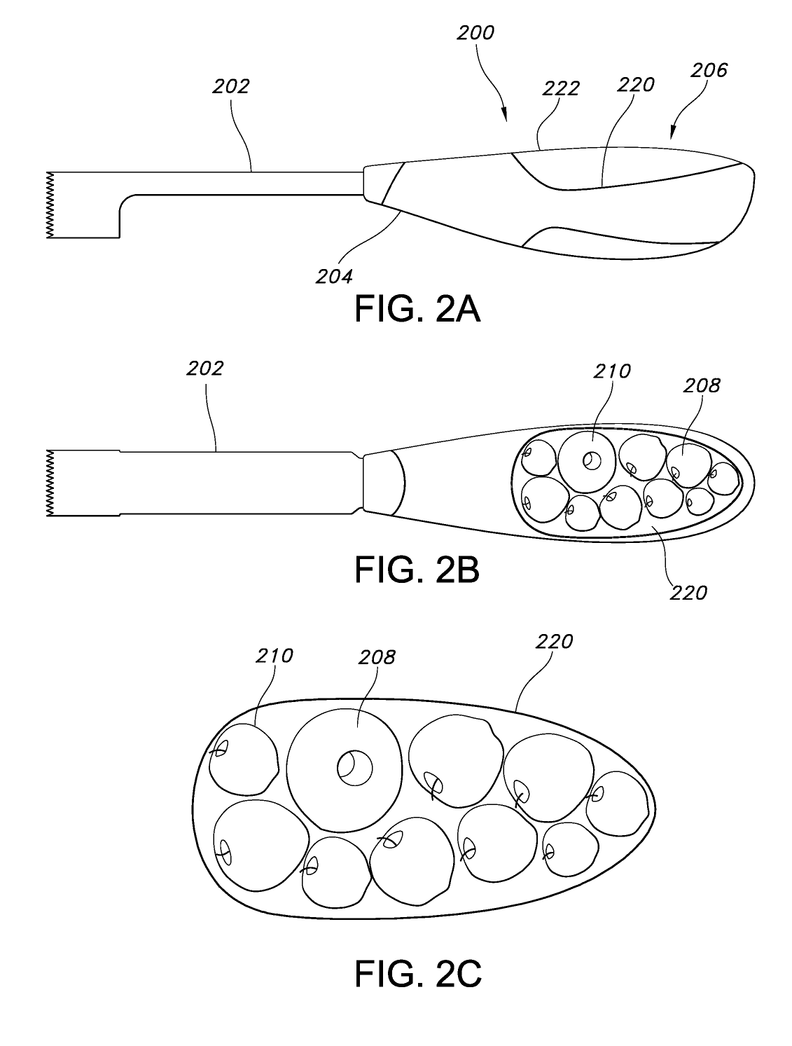

Referring now to FIGS. 2A-C an apple corer 200 in accordance with an exemplary embodiment of the present invention is generally illustrated. The apple corer 200 is designed to facilitate easy identification of the apple corer 200 and the function of the apple corer 200. The apple corer 200 includes a tool portion 202 disposed on one end of the apple corer 200 and a handle portion 204 disposed on the opposite end of the apple corer 200.

The handle portion 204 includes indication means 206 being a graphic element 220 located within the handle portion 204, under a see-through element 222. The graphic element 220 illustrates one or more apples 208, which is the item that the apple corer 200 is designed to be used on. Additionally, the graphic portion 206 also illustrates a cored apple 210 that shows the function of the apple corer 200. In exemplary embodiments, the handle portion 204 of the apple corer 200 can be predominantly red, or the color of one type of an apple, to aide a user in the expeditious identification of the apple corer 200.

### Avocado Slicer

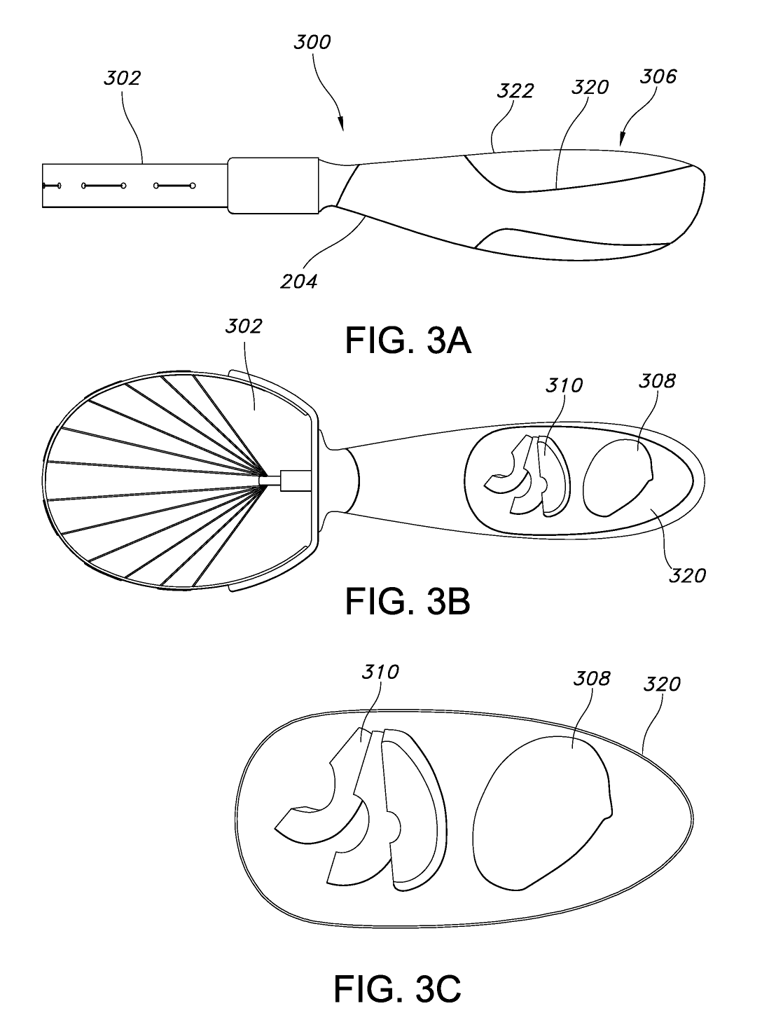

Turning now to FIGS. 3A-C an avocado slicer 300 in accordance with an exemplary embodiment of the present invention is generally illustrated. The avocado slicer 300 is designed to facilitate easy identification of the avocado slicer 300 and the function of the avocado slicer 300. The avocado slicer 300 includes a tool portion 302 disposed on one end of the avocado slicer 300 and a handle portion 304 disposed on the opposite end of the avocado slicer 300.

The handle portion 304 includes a graphic element 322 that illustrates one or more avocados 308, which is the item that the avocado slicer 300 is designed to be used on. Additionally, the graphic portion 306 also illustrates a sliced avocado 310 that shows the function of the avocado slicer 300. In exemplary embodiments, the handle portion 304 of the avocado slicer 300 can be predominantly green, or the color of an avocado, to aide a user in the expeditious identification of the avocado slicer 300.

### Melon Cutter

The present invention can further comprise a melon cutter being designed to facilitate easy identification of the melon corer and its function via indication means. The tool portion of the melon cutter can be a v-cutter with serrated edges, and the handle portion can include a two- or three-dimensional representation of a melon, and a cut melon.

Cantaloupes and honeydew melons are conventionally severed continuously and in an annular cut around midsections in a fancy cutting operation in supermarkets and catering operations. The fancy cut is usually a serration with the melon being thus split into half sections, the seeds and other material in the central portion removed and the melon thereafter filled with grapes, portions of other melons, and various other colorful fruit in a pleasing and appetizing display. The present cutter can utilize a knife with a “V” shaped cross section to provide the continuous cut around the mid section of the melon, accomplished incrementally in small stabbing type cuts.

### Lettuce Knife

Due to a lack of alternatives, metal knives are often used for tasks for which they are poorly suited. One example is a metal knife to cut lettuce. The metal knife promotes oxidation of the cut lettuce, turning the trimmed portion of the lettuce from green to an unappetizing dark brown.

The present invention can further comprise a lettuce knife being designed to facilitate easy identification of the lettuce knife and its function via indication means. The tool portion of the lettuce knife can be a plastic blade having a cutting edge that extends from the blade in a downward direction. The cutting edge can include a series of curved segments that are preferably arcuate and convex in shape and intersect one another at an angle. This arrangement increases the length of the cutting edge of the lettuce knife.

The handle portion of the knife cutter can include a two- or three-dimensional representation of a head of lettuce, and shred lettuce.

As discussed above, the lemon zester 100, the apple corer 200, and the avocado slicer 300 are non-limiting exemplary embodiments of a specialized utensil and other embodiments are also contemplated. Other designs include the melon cutter and lettuce knife, and others including a basting brush, a tomato corer, and a cheese grater, just to name a few.

The graphical representation of the function of the specialized utensil on the handle portion of the utensil permits users that are unfamiliar with the specialized utensil to quickly and easily identify the specialized utensil and its function. Furthermore, the function of the specialized utensil, as shown by the graphical representation, is easily understood by individuals that are familiar with the items depicted by the graphical representation, regardless of the languages or background of the individual. For example, a user that is not familiar with an apple corer 200, but know what an apple is, will be able to easily identify the apple corer 200 and its function based on the graphical illustrations of an apple 208 and a cored apple 210. Additionally, the user will be able to quickly identify the apple corer 200 amongst several similarly sized specialized utensils based partially on the predominantly red color of the handle portion 204 of the apple corer 200.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as can be suggested by the teachings herein are particularly reserved as they fall within the breadth and scope of the claims here appended.

What is claimed is:

1. A utensil for an item comprising:
a tool end for acting on the item; and
indication means representing the item.

2. The utensil of claim 1, the indication means comprising a visual two-dimensional graphical representation of the item.

3. The utensil of claim 1, the indication means comprising a three-dimensional representation of the item.

4. The utensil of claim 1, the indication means comprising a non-visual representation of the item.

5. The utensil of claim 2, the indication means further comprising a graphical representation of the use of the utensil.

6. The utensil of claim 1, the indication means comprising a two-dimensional representation of the item located in a handle portion of the utensil, the two-dimensional representation of the item being located in a recess of the handle portion.

7. The utensil of claim 6, the recess of the handle portion being covered by an at least translucent cover, through which the two-dimensional representation can be viewed.

8. The utensil of claim 1, the indication means comprising a three-dimensional representation of the item located in a handle portion of the utensil, at least a portion of the three-dimensional representation of the item being located in a recess of the handle portion

9. A food processing utensil comprising:
a functional tool disposed on one end of the utensil;
a handle disposed on a second end of the utensil; and
indication means representing the food to be processed by the utensil.

10. The utensil of claim 9, wherein the utensil is an item of cutlery.

11. The utensil of claim 9, wherein the indication means represents both the food to be processed by the utensil and the function of the utensil on the food, and wherein the handle comprises a recessed portion covered by an at least translucent cover through which the recess can be viewed, the indication means located within the recess.

12. The utensil of claim 11, the utensil comprising a lemon zester.

13. The utensil of claim 11, the utensil comprising an apple corer.

14. The utensil of claim 11, the utensil comprising an avocado slicer.

15. The utensil of claim 11, the utensil comprising a melon cutter.

16. The utensil of claim 11, the utensil comprising a lettuce knife.

17. The utensil of claim 11, the utensil comprising a basting brush.

18. The utensil of claim 11, the utensil comprising a tomato corer.

19. The utensil of claim 11, the utensil comprising a cheese grater.
